(19) United States
(12) Patent Application Publication
(10) Pub. No.: US 2011/0260973 A1
(43) Pub. Date: Oct. 27, 2011

(54) ROTATIONAL MOUSE

(76) Inventor: Sang-Cheal Kim, Kyeonggi-Do (KR)

(21) Appl. No.: 13/126,095

(22) PCT Filed: Nov. 23, 2010
(86) PCT No.: PCT/KR2010/008293

§ 371 Date: Apr. 26, 2011

(30) Foreign Application Priority Data
Nov. 26, 2009 (KR) 10-2009-0115030

(51) Int. Cl. G06F 3/033

(52) U.S. Cl. 345/163

(57) ABSTRACT

This invention is concerning a mouse that is characterized by the way it moves like a swimming fish, and an objective is to provide a mouse configured to prevent sweat from collecting in the hand. The mouse in this invention designed to achieve said objective and is characterized by comprising: a body having buttons mounted on the top of the mouse that emits electrical signals, a button mounted on the bottom that recognizes the movements; wherein one side of said body is joined by a hinge to provide a rotating part that can rotate.

### CLAIM OF PRIORITY

The present patent application claims priority to a Patent Cooperation Treaty patent application having Serial Number PCT/KR2010/008293 filed on Nov. 23, 2010, which claims priority to an original patent application filed in The Republic of Korea on Nov. 26, 2009 and having Serial Number 10-2009-0115030, now Republic of Korea Patent No. 10-0952288, both of which are incorporated herein by reference in their entirety.

### BACKGROUND OF THE INVENTION

1. Field of the Invention

### The Area of Technology

This invention is regarding a mouse; in particular its movements are like a swimming fish, and it is designed to prevent sweat from collecting in the hand.

2. Description of the Related Art

### Background Technology

The mouse is one of the input devices used when moving the pointer, etc. on the computer screen, and one can do various things with it, such as: put the pointer at a certain place on the screen and press (click) the button (click), drag (drag) the mouse while still pressing the button, press the button consecutively and rapidly twice (double click), and etc.

FIG. 1 is an illustration showing the mouse according to the conventional technology.

As shown in FIG. 1, the mouse (1) has two buttons (5) on the right and left sides wherein a wheel (7) between the two buttons (5), and the cable (9) connected to the buttons (5) and the wheel (7) through the vertical hem of the mouse (1). The case (3) of the mouse (1) protrudes behind the buttons (5) designed to give a comfort to the palm of the hand that rests on the protruded area when the index and middle fingers are placed on the two buttons (5).

However, the present mouses in commercial use only differ in sizes on the whole, and because most of them are similar to the mouse described earlier, they lack the esthetics, which is their drawback.

Additionally, because the palm of the hand comes in contact with the protruded area, there is no ventilation and sweat is collected in the hand, which is a problem.

### SUMMARY OF THE INVENTION

### What this Technology Attempts to Achieve

This invention was devised in order to resolve the problems with the conventional technology as explained earlier, and its objective is to provide a mouse that moves in the manner such as a swimming fish by: joining the center of the mouse by a hinge to have its vertical hem and the rear end to rotate in relation to each other.

Additionally, the object of this invention is to provide a mouse designed to prevent the collection of sweat with the mouse by configuring a gap where the palm of the hand is placed.

### Resolution Method

The mouse in this invention devised to achieve the said goals is characterized by comprising: buttons mounted on the top that emit electrical signals, and the body where sensor(s) that recognize movements are mounted and the rotating part that is joined by a hinge onto a side of the said body.

Additionally, according to a preferred embodiment of this invention, the said rotating part joined to a side of the said body by a hinge and extends outward from the body along the center axis that curves down, and the braces that are separated vertically along the said center axis and curve down both sides.

Additionally, according to a preferred embodiment of this invention, said rotating part is comprised of: the center axis that is joined by a hinge onto the bottom of said body and extends outward from the body, and the supports secured to the top part along the length of said center axis.

Additionally, according to a preferred embodiment of this invention, the said supports are configured so that the supports towards the front are larger than the supports towards the rear wherein the exterior shape formed by the supports creates an upward protrusion.

Additionally, according to a preferred embodiment of this invention, the middle of the said center axis is joined by a hinge.

Additionally, according to a preferred embodiment of this inventions, on a side of the said body is configured Lug #1, on the ends of the center axis is configured a pair of Lug #2s that correspond to the top and bottom of said Lug #1, on one side between either the top and bottom of said Lug #1 is configured a groove wherein Lug #2 is inserted, and on the other side is configured a step surface wherein Lug #2 is securely placed. Additionally, according to a preferred embodiment of this invention, a USB port is installed in the said body.

### Effects of this Invention

As explained earlier, the mouse in this invention inputs electrical signals as the user places his/her index and middle fingers on the buttons while pressing the rotating part of the mouse with the palm of his/her hands. Accordingly, it causes less fatigue on the wrist than the conventional mouse because the wrist movement is lesser than when one moves the entire mouse, which is strength for this invention.

Additionally, by configuring a gap in the mouse's rotating part that supports the palm of the hand, the mouse in this invention does not cause sweat to collect in the palm of the hand, which is strength for this invention.

Additionally, because the body of the mouse and the rotating part are joined by a hinge, thus enabling the rotating part to turn right and left as if a fish is swimming—because it can move in that manner, it can be more esthetic than the conventional, uniform configuration, which is a strength for this invention.

### BRIEF DESCRIPTION OF THE FIGURES

FIG. 1 is an illustration that shows the mouse by the conventional technology.

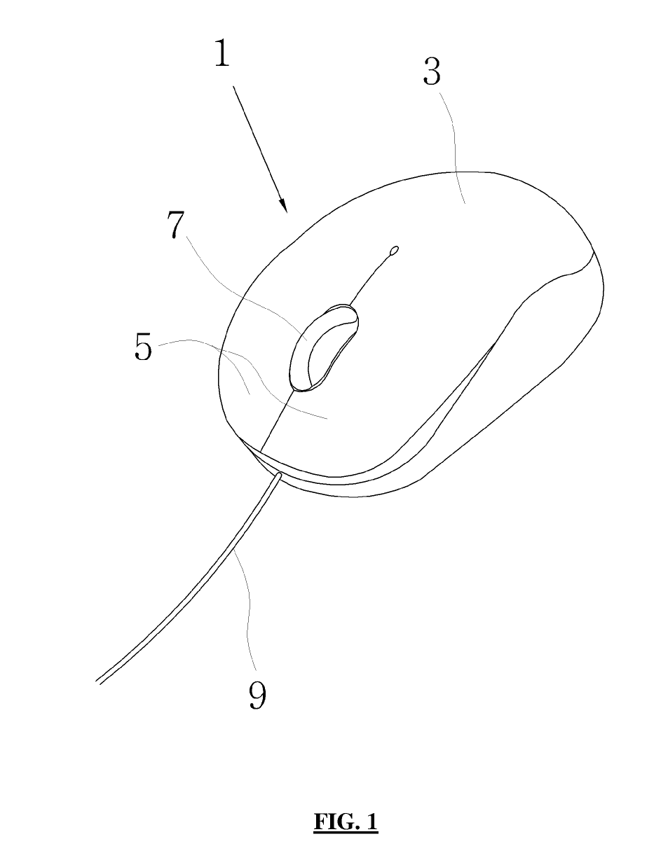

FIG. 2 is an illustration that shows the mouse moving with the movements of a fish according to this invention's Preferred Embodiment 1.

FIG. 3 is a two-dimensional drawing showing the movement of the mouse illustrated in FIG. 2.

FIG. 4 is a sectional drawing that shows the area of the mouse illustrated in FIG. 2 joined by the hinge.

FIG. 5 is an illustration that shows the mouse looking like a swimming fish according to this invention's Preferred Embodiment 2.

FIG. 6 is a two-dimensional drawing showing the movement of the mouse illustrated in FIG. 5.

FIG. 7 is a partial, 2-dimensional drawing showing the area of the mouse illustrated in FIG. 5 joined by a hinge.

*explanation of the signs on important parts of the mouse*

| | |
|---|---|
| 100: Mouse | 110: the body |
| 113: USB port | |
| 115L: left button, | 115R: right button |
| 117: wheel, | 119: cable |
| 121: Lug #1, | 123: groove |
| 125: the step surface | 127: LED |
| 130: Joined by hinge | 131: hinge axis |
| 140: rotating part | 141: Lug #2 |
| 143: center axis | 145: brace |
| 147: supporting part | |

### DETAILED DESCRIPTION

### The Optimal Shape for this Invention's Embodiments

Below is a detailed explanation of this invention's good mouse embodiments while referring to the attached drawings.

### Embodiment Example #1

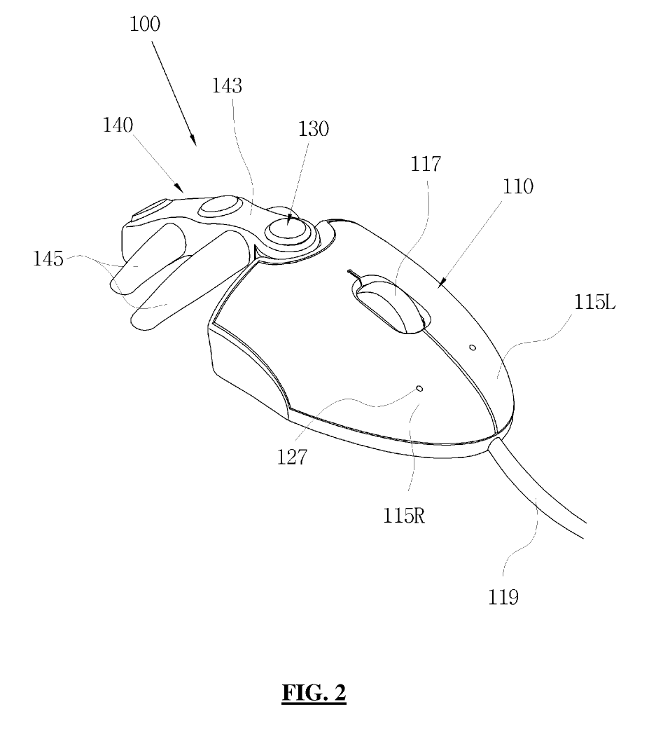

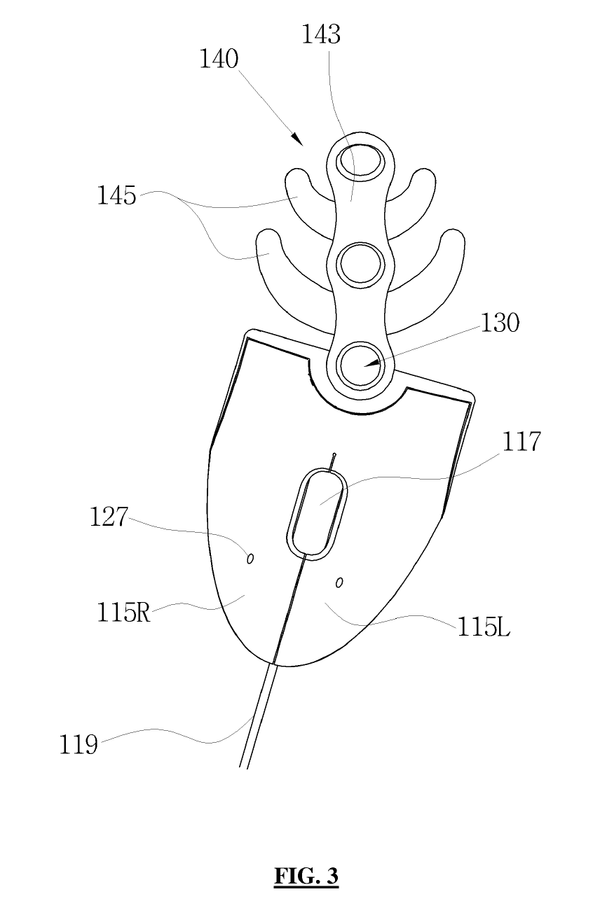

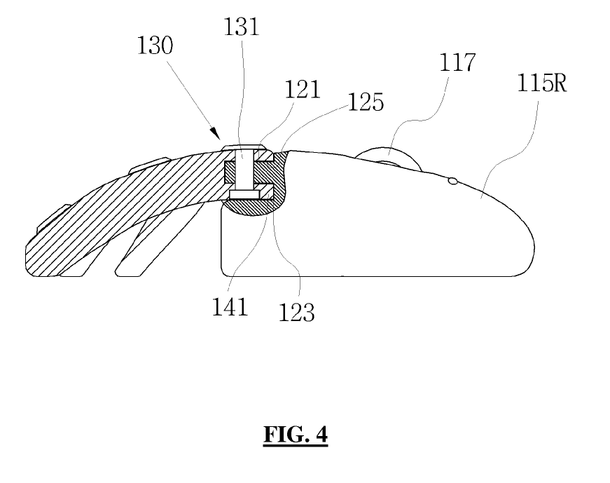

In the drawings, FIG. 2 is an illustration that shows the mouse looking like a swimming fish according to this invention's Embodiment Example #1; FIG. 3 is a two-dimensional drawing showing the movement of the mouse illustrated in FIG. 2; and FIG. 4 is a sectional drawing showing the part of the mouse joined by a hinge as illustrated in FIG. 2.

FIGS. 2 & 3 shows that the mouse (100) is comprised of: the body (110) where there are a left button (115L), a right button (115R) and a wheel (117); and the rotating part (140) that is joined to the said body (110) by a hinge and extended toward the back and turns left and right centered around the area joined (130) by a hinge.

Below is a specific explanation about the mouse thus configured.

In the vertical hem of the body (110), the cable (119) is extended and connected to the computer; the cable (119) is connected within the body (110) to the left button (115L), right button (115R) and the wheel (117). Although this was not illustrated in a drawing, in the bottom of the body (110) is mounted an optical sensor which emits electrical signals having a two-dimensional coordinates concerning the body's (110) movement. Such left button (115L), right button (115R), wheel (117) and optical sensor are the same as the configuration elements of mouse already being commercialized, and therefore, a specific explanation is omitted.

As shown in FIG. 4, in the rear side of the body (110), the rotating part (140) is joined by a hinge.

In the top of the back side of the body (110) is Lug #1 (121) protruding toward the back; and a pair of the Lugs #2 (141) on the vertical hem of the rotating part (140) is joined to the said Lug #1 (121).

The said rotating part (140) is comprised of the center axis (143) that curves down and backward to touch the desk surface and the brace (145) formed symmetrically to the left and right of the gap which exists along the said center axis (143) in lengthwise; because of the gap between the brace (145) creates a ventilation, sweat does not collect. Said left button (115L), the right button (115R) and said brace (145) are made of silicon, and therefore, when the hand is placed on the mouse (100), it provides a good grip feel.

To be more specific, on the vertical hem of the center axis (143) is a set of Lugs #2 (141); as you go farther toward the back end, the shape curves down and thus the back end touches the desk surface. Here are a pair of Lugs #2 (141) in parallel, and in between the Lugs #2 is inserted Lug #1 (121) of the body (110). In order for Lug #1 (121) to be inserted between the Lugs #₂ (141) in the body (110), a groove (123) wherein Lugs #2 (141) can be inserted below Lug #1 (121) is formed. Additionally, on the top of the Lug #1 (121) is formed a step surface (125) in the shape of a semi circle that corresponds to Lugs #2 (141) in order to facilitate uninhibited rotation while Lug #2s (141) are in stable positions.

Accordingly, if Lug #1 (121) is inserted between the Lugs #2 (141), the Lug #2 (121) that is below Lug #1 (121) is inserted into the groove (123) in the body (110); and Lug #2 (141) that is above Lug #1 (121) is positioned correspondingly to the step surface (125).

While Lug #1 (121) Is inserted in between Lugs #2 (141), the holes in Lug #1 (121) and Lugs #2 (141) line up, and through the holes of the Lug #1 (121) and Lugs #2 (141) is put through the hinge axis and thus joined by the hinge.

Additionally the brace (145) extended to the right of the center axis (143) curves down toward the desk surface. Additionally, on the left button (115L) and the right button (115R), respectively, is a LED (127) each, making it possible to emit light from the left button (115L) and the right button (115R).

Below is an explanation about how to use a mouse thus configured.

The user places his/her hand on the rotating part (140), then place the index and middle fingers on the body's (110) left button (115L) and right button (115R), respectively. In this state, if the user presses the left (115L) and the right (115R) buttons to generate the electric signal, the red electric signal emitted by the mouse (100) is input into the computer's CPU. Depending on the necessity, the wheel (117) can be rotated to input the signal.

As shown in FIG. 3, if the body (110) of the mouse (100) on which the user places his/her index and middle fingers is moved to left and to the right, then relative to that, while the rotating part (140) is still being pressed by the palm, the body (110) rotates around the area joined by the hinge (130) and moves the pointer on the screen to the right and to the left. If the user wishes to move the pointer to front and back, if he/she moves the body (110), then it will move front and back with the hinge-joined rotating part (140) and the body (110).

If the user takes his/her hand off of the mouse (100), the body (110) and the rotating part (140) will be in a position after having rotated around the hinge axis (131). Additionally, if the user holds tightly to the body (110) and rotates the rotating part (140), the rotating part (140) will rotate to the right and left showing movements of a swimming fish.

Depending on the situation, the center axis (143) in the Embodiment #1 can be divided into multiple pieces, and the divided parts can be joined by a hinge to configure the center axis to rotate at a number of points.

### Embodiment Example #2

When comparing the mouse described in the Embodiment Example #1 to the mouse according to Embodiment Example #2, the only differences are the center axis of the rotating part being joined to the back end bottom side of the body, and the palm of the hand gets placed on the supports secured onto the center axis; and the other components are the same or similar to those described in Embodiment Example #1. Accordingly, a detailed explanation about the components described in Embodiment Example # 1 will be omitted and the same signs will be used.

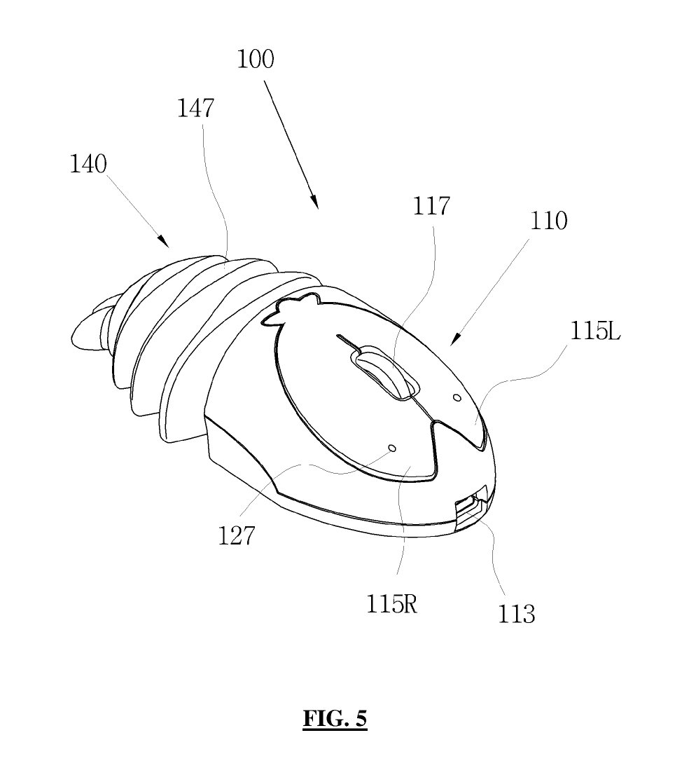

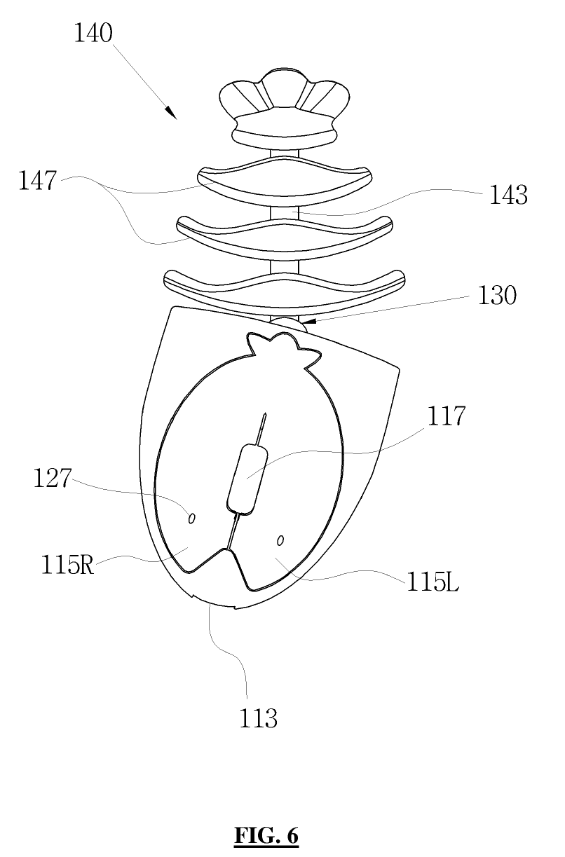

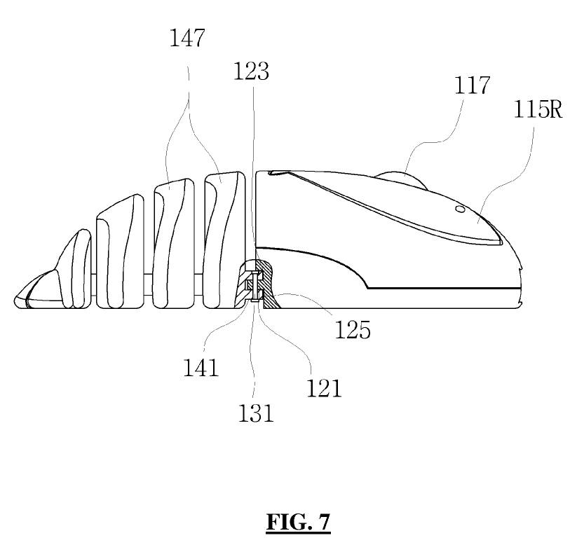

FIG. 5 is an illustration showing the mouse looking like a fish according to Embodiment Example 2; FIG. 6 is a two-dimensional drawing showing the movement of the mouse illustrated in FIG. 5; FIG. 7 is a partial, sectional drawing showing the area of the mouse joined by a hinge as illustrated in FIG. 5.

As illustrated in FIGS. 5 through 7, onto the body (110) are mounted the left button (115L), right button (115R) and the wheel (117); and the cable (119) extending from the computer connects to the USB port (113) configured on the vertical hem of the body (110).

On the back end bottom of the body (110) is formed Lug #1 (121), and onto Lug #1 (121) of the body (110) is joined Lug #2 (141) of the rotating part (141) by a hinge. There is a pair of Lugs #2 (141) where in Lug #1 (121) is inserted in between the two and joined by a hinge.

In the center axis (143) of the rotating part (140) joined to the body (110) by a hinge in this manner are secured the supports (147) spread apart lengthwise in a semi circular shape; they are secured to the top of the center axis (143) the said supports (147) are secured to the center axis (143) lengthwise wherein the area of the supports (147) toward the front is larger than the area of the supports (147) toward the rear. Accordingly, the farther toward the rear along the center axis (143) the area of the supports (147) gets smaller forming an upwardly protruding exterior due to the supports (147). The said left (115L) and right (115R) buttons and said brace (147) are made of silicon, providing a good grip feel when placing the hand on the mouse (100).

The step surface (125) in the mouse (100) according to Embodiment Example 2 is configured on the bottom of Lug #1 (121), and the groove (123) wherein Lug #2 (141) is inserted is configured on the top of Lug #1 (121).

When a user uses the mouse (100) according to Embodiment Example 2, the palm of the user's hand is placed to contact the protrusion by the supports (147). In other words, the palm comes in contact with the top of the supports (147) and the index and middle fingers are placed on the body's (110) left (115L) and right (115R) buttons. Here, through the gap between the supports (147) ventilation occurs; thus sweat does not collect in the palm.

If the mouse (100) is moved to the left and right in this state, the body (110) moves to the left and right of the rotating part (140).

Also concerning the rotating part (140) according to Embodiment Example 2, in a number of spots in the center axis (143), a number of hinged joints can be configured along its length so that rotation can occur at various points of the center axis (143). Additionally, on the vertical hem of the mouse (100) described earlier is configured a USB port (113) connecting to the cable (119) extended from the computer, making it easy to move and convenient to handle the cable (119).

Additionally, in addition to the wired mouse described earlier, the technical ideology of this invention can also apply to a wireless mouse not using the cable.

What is claimed is:

1. A mouse characterized by being comprised of: the body which have buttons that emit electrical signals mounted on top and also have sensor that recognizes movements on the bottom; the center axis which although is joined by a hinge to a side of the said body to include a part that can rotate where said rotating part is joined to said body's one side of the top by a hinge and extended outward and curves down to the desk surface wherein along said center axis are braces that are spread out lengthwise on either side of the gap along center axis and curved downward to the desk surface.

2. A mouse characterized by being comprised of: the body wherein on its top, buttons that emit electrical signals are mounted, and on its bottom is the sensor that recognizes movements is mounted; a rotating part that is joined by a hinge to one side of the said body and is able to rotate wherein said rotating part is joined by a hinge to the bottom of one side of said body; wherein the center axis extends outward from the body; wherein supports spread out lengthwise along the center axis and secured to the top part.

3. A mouse characterized by its configuration: wherein said supports toward the front have a larger area than the supports toward the rear and therefore the exterior shape formed by the supports create an upward protrusion as in claim 2.

4. A mouse characterized by the middle of the length of said center axis is joined by a hinge as in claim 1.

5. A mouse characterized by its configuration: wherein Lug #1 is configured on one side of said body; wherein at the ends of the center axis is a pair of Lugs #2 that correspond to the top and bottom ends of said Lug #1; wherein on one side, whether top or bottom, of said Lug #1 is configured a groove wherein Lug #2 is inserted and on the other side is configured a step surface where Lug #2 is securely placed as claim 4.

6. A mouse characterized by a USB port is mounted onto its body as in claim 1.

7. A mouse characterized by the middle of the length of said center axis is joined by a hinge as in claim 2.

8. A mouse characterized by a USB port is mounted onto its body as in claim 3.
